(19) United States
(12) Patent Application Publication
(10) Pub. No.: US 2025/0047040 A1
(43) Pub. Date: Feb. 6, 2025

(54) LEAD FRAME WITH ELECTRICAL SHORTING PROTECTION

(71) Applicant: Samtec, Inc., New Albany, IN (US)

(72) Inventors: Aaron TUCKER, New Albany, IN (US); Richard L. JONES, III, New Albany, IN (US)

(21) Appl. No.: 18/715,484

(22) PCT Filed: Jan. 18, 2023
(86) PCT No.: PCT/US2023/011028

§ 371 Date: May 31, 2024

Related U.S. Application Data
(60) Provisional application No. 63/300,996, filed on Jan. 19, 2022.

(51) Int. Cl. H01R 13/6471; H01R 13/6591; H01R 13/6592

(52) U.S. Cl. CPC H01R 13/6471; H01R 13/65915; H01R 13/6592

(57) ABSTRACT

A cable termination that helps prevent unwanted, inadvertent electrical shorting between a signal conductor and a cable ground shield, cable serve shield, or cable reference shield of a cable, such as a coaxial or twin axial cable.

### CROSS REFERENCE TO RELATED APPLICATIONS

This application claims the benefit of U.S. Patent Application No. 63/300,996 filed on Jan. 19, 2022. The entire contents of this application are hereby incorporated by reference.

### BACKGROUND OF THE INVENTION

### 1. Field of the Invention

Embodiments described herein generally relate to electrical cable connectors and components used with electrical cable connectors.

### 2. Other Technical Approaches

A shielded cable conductor is attached to a corresponding electrical conductor. One or more of an outer jacket, a cable shield, and a cable dielectric are stripped away, exposing one or more cable conductors, the cable shield, and the cable dielectric.

### SUMMARY OF THE INVENTION

Minimizing a cable strip region of a cable, such as a coaxial cable, a twin axial cable, a discrete wire cable, a flex cable, or other cable can increase the signal integrity of a first connector, such as an electrical cable connector. However, care must be taken to space a cable ground shield from a corresponding first conductor, a corresponding second conductor, or both the first and second corresponding conductors. Otherwise, unwanted electrical shorting can occur.

In general, unwanted electrical shorting can be greatly reduced or virtually eliminated by an electrically non-conductive barrier positioned adjacent to a respective mount end of a signal conductor. An electrically non-conductive barrier, such as a first barrier, can be positioned between a cable ground shield and a material thickness edge, such as a first material thickness edge, of a corresponding electrical conductor, such as a first electrical conductor.

An electrical connector according to an embodiment of the present invention includes a leadframe housing, a first electrical conductor that defines a first material thickness edge, and an electrically non-conductive barrier positioned on or adjacent to the first material thickness edge. The barrier is carried by the leadframe housing.

The electrical connector can further include a second electrical conductor that defines a second material thickness edge and an electrically non-conductive barrier positioned on or adjacent to the second material thickness edge. The electrical connector can further include a cable that includes a cable shield. The cable shield can be electrically insulated from the first material thickness edge, and the cable shield can be electrically insulated from the second material thickness edge. The cable shield can define a shield edge, and the shield edge can be positioned approximately greater than 0 mm to approximately 0.24 mm from the second material thickness edge.

The electrical connector can further include a first cable conductor electrically connected, physically connected, or both electrically and physically connected to a first mount portion of the first electrical conductor. The electrical connector can further include a second electrical conductor and a second cable conductor electrically connected, physically connected, or both electrically and physically connected to a second mount portion of the second electrical conductor. The barrier can be non-removably attached to the leadframe housing. The barrier can be configured to be provided by a single dipping operation.

An electrical connector according to an embodiment of the present invention includes a leadframe housing, a first differential signal pair carried by the leadframe housing, the first differential signal pair including a first electrical conductor and a second electrical conductor, the first electrical conductor including a first mount portion and the second electrical conductor including a second mount portion, the first mount portion including a first material thickness edge and the second mount portion including a second material thickness edge, and a twin axial cable electrically connected, physically connected, or both electrically and physically connected to the respective first electrical conductor and the respective second electrical conductor. The twin axial cable includes a cable shield, the cable shield defines a shield edge, and the shield edge either is spaced greater than approximately 0 mm but less or equal to approximately 0.24 mm from the first material thickness edge and/or the second material thickness edge or extends beyond or over the first material thickness edge and/or the second material thickness edge.

The shield edge can be spaced greater than approximately 0 mm but less than 0.25 mm from the first material thickness edge and/or the second material thickness edge. The shield edge can be spaced greater than approximately 0 mm but less than approximately 0.5 mm from the first material thickness edge and/or the second material thickness edge. The shield edge can be spaced greater than approximately 0 mm but less than approximately 1 mm from the first material thickness edge and the second material thickness edge.

An electrical connector according to an embodiment of the present invention includes a leadframe housing, a first differential signal pair carried by the leadframe housing, the first differential signal pair including a first electrical conductor and a second electrical conductor, the first electrical conductor including a first mount portion and the second electrical conductor including a second mount portion, the first mount portion including a first material thickness edge and the second mount portion including a second material thickness edge, a first barrier positioned on or adjacent to the first material thickness edge and a second electrically dielectric barrier positioned on or adjacent to the second material edge, a twin axial cable electrically connected, physically connected, or both electrically and physically connected to the respective first electrical conductor and the respective second electrical conductor. The twin axial cable includes a cable shield, the cable shield defines a shield edge, and the shield edge is spaced greater than approximately 0 mm but less than approximately 0.24 mm from the first and/or the second electrically dielectric barriers.

An electrical connector according to an embodiment of the present invention includes a first electrical conductor that defines a first material thickness edge, a second electrical conductor that defines a second material thickness edge, an electrically non-conductive first barrier positioned on the first material thickness edge, and an electrically non-conductive second barrier positioned on the second material thickness edge. The first barrier and the second barrier are discrete and independent.

The first and the second barriers may not span both the first electrical conductor and the second electrical conductor. The first and the second barriers may not receive a first cable conductor, a second cable conductor, or both the first and the second cable conductors. The first barrier can have a thickness greater than approximately zero microns and less than or equal to one micron. The first barrier can have a thickness greater than approximately zero microns and less than or equal to approximately ten microns.

An electrical connector according to an embodiment of the present invention includes a first electrical conductor and a second electrical conductor. At least one of the first electrical conductor and the second electrical conductor includes a chamfered surface.

The chamfered surface can be greater than approximately one micron and less than or equal to approximately seven microns. The first electrical conductor can include a first chamfered surface, and the second electrical conductor can include a second chamfered surface. The first chamfered surface and the second chamfered surface can be symmetrical with respect to a longitudinal center line of the electrical connector.

The electrical connector can further include a cable connected to at least one of the first electrical conductor and the second electrical conductor. The electrical connector can further include a cable connected to each of the first electrical conductor and the second electrical conductor. The cable can be a twin axial cable. The first electrical conductor and the second electrical conductor can define a differential pair.

An electrical connector according to an embodiment of the present invention includes a first electrical conductor including a first chamfered surface, a second electrical conductor including a second chamfered surface, and a twin axial cable electrically connected, physically connected, or both electrically and physically connected to each of the first electrical conductor and the second electrical conductor.

The twin axial cable can include a cable shield, a surface of the first electrical conductor that is closest to the cable shield can be the first chamfered surface, and a surface of the second electrical conductor that is closest to the cable shield can be the second chamfered surface. The twin axial cable can include a cable dielectric, and the cable dielectric can extend beyond the cable shield.

The first chamfered surface and the second chamfered surface can be each defined by straight lines. The first chamfered surface and the second chamfered surface can be each defined by a semicircular shape. The first chamfered surface can be applied to a distance that is less than or equal to about ⅔ of a width of the first electrical conductor along each of the width and a length of the first electrical conductor, and the second chamfered surface can be applied to a distance that is less than or equal to about ⅔ of a width of the second electrical conductor along each of the width and a length of the second electrical conductor.

The first electrical conductor and the second electrical conductor can define a differential signal pair.

The electrical connector can further include a leadframe housing, and the first electrical conductor and the second electrical conductor can be carried by the leadframe housing. The electrical connector can further include a first electrically non-conductive barrier provided on a first material thickness edge of the first electrical conductor, and a second electrically non-conductive barrier provided on a second material thickness edge of the second electrical conductor. Each of the first electrically non-conductive barrier and the second electrically non-conductive barrier can be carried by the leadframe housing.

An electrical connector according to an embodiment of the present invention includes a first electrical conductor including a first chamfered surface at a first cable attachment end and a second electrical conductor including a second chamfered surface at a second cable attachment end.

The above and other features, elements, characteristics, steps, and advantages of the present invention will become more apparent from the following detailed description of the embodiments of the present invention with reference to the attached drawings.

### BRIEF DESCRIPTION OF THE DRAWINGS

FIG. 1 is a perspective, cross-sectional side view of a first electrical connector.

FIG. 2 is a perspective top view of a leadframe housing that carries at least one signal conductor.

FIG. 3 is a perspective view of a second electrical connector.

FIG. 4 is a cross-sectional side view of a leadframe housing of the second electrical connector shown in FIG. 3.

FIGS. 5A to 5C show examples of implementations for the leadframe housing shown in FIG. 4.

FIG. 6 is a cross-sectional side view of an experimental example of the leadframe housing of the second electrical connector shown in FIG. 3.

### DETAILED DESCRIPTION

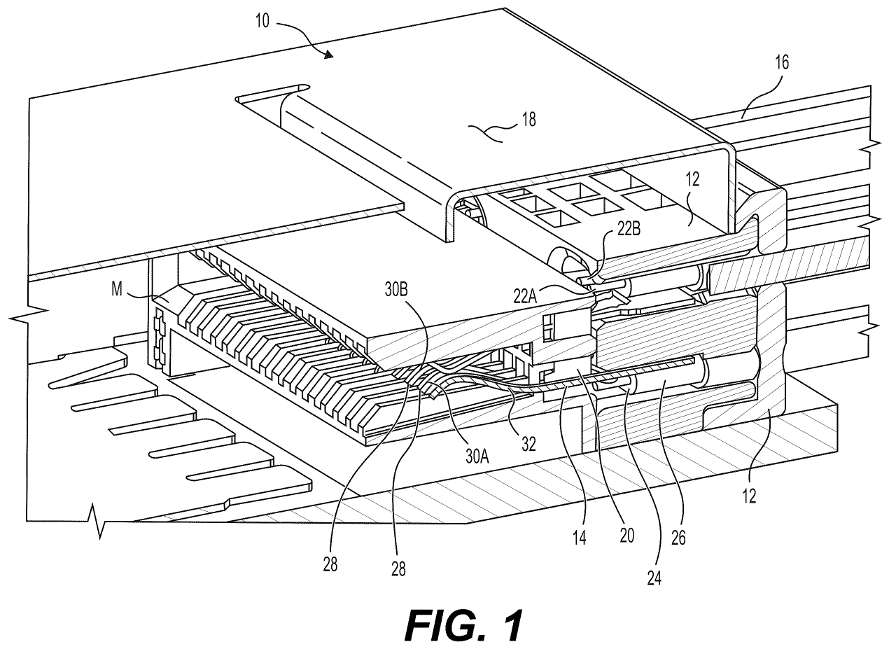

FIG. 1 shows a first electrical connector, such as an electrical cable connector 10. Electrical cable connector 10 can include an electrically insulative, dielectric housing 12; at least one, at least two, at least three, at least four, or four or more electrical conductors 14; one, at least one, at least two, at least three, at least four, or four or more cables 16, such as coaxial, flex, discrete, or twin axial cables; an optional EMI shield 18; optional interleaved crosstalk shields (not shown), and an electrically insulative, dielectric overmolded leadframe housing 20. Alternatively, the leadframe housing 20 can be omitted, and the electrical conductors 14 can be stitched into housing 12.

The housing 12 can be made from, or can include, a plastic material, a magnetic absorbing material, or both a plastic and a magnetic absorbing material. The at least one, at least two, at least three, at least four, or four or more electrical conductors 14 can each be made from, include, or contain an electrically conductive material, such as copper, beryllium copper, phosphorus bronze, gold, silver, palladium, nickel, a metal, or a metal alloy. Each cable 16 can include at least one first cable conductor 22A and/or at least one second cable conductor 22B. Each first cable conductor 22A, each second cable conductor 22B, or both first cable conductor 22A and second cable conductor 22B can be made from, include, or contain an electrically conductive material, such as copper, beryllium copper, phosphorus bronze, gold, silver, palladium, nickel, a metal, or a metal alloy. Each electrical cable 16 can include a cable dielectric 24 and a cable shield 26. The cable dielectric 24 can be made from, include, or contain an electrically non-conductive material, such as a plastic material, a magnetic absorbing material, both a plastic and a magnetic absorbing material, etc. The cable shield 26 can be made from, or include, an electrically conductive material, such as copper, a metal, or a metal alloy.

Leadframe housing 20 can be made from, include, or contain a plastic, a magnetic absorbing material, or both a plastic and a magnetic absorbing material. Each respective leadframe housing 20 can carry electrical conductors or contacts. The electrical conductors can be signal conductors and/or ground conductors. The signal conductors can be single ended or can be paired in differential signal pairs. The signal conductors can include at least one differential signal pair, at least two differential signal pairs, at least three differential signal pairs, or more than three differential signal pairs 28. Each respective differential signal pair 28 can include a first electrical conductor 30A and a second electrical conductor 30B. Each first electrical conductor 30A can be made from an electrically conductive material, such as copper, beryllium copper, phosphorus bronze, gold, silver, palladium, nickel, a metal, or a metal alloy. Each second electrical conductor 30B can be made from an electrically conductive material, such as copper, beryllium copper, phosphorus bronze, gold, silver, palladium, nickel, a metal, or a metal alloy. The first electrical conductor 30A can be a signal conductor. The second electrical conductor 30B can be a signal conductor. The leadframe housing 20 can carry signal and ground conductors 32 in any suitable arrangement, including, for example, a S-G-S-G repeating pattern, in a S-S-G repeating pattern, or a S-S-G-G repeating pattern. Mating interface M can define a slot configured to receive a card edge or a portion of a mating connector. In other embodiments, the housing 12 can be devoid of a slot. In other embodiments, the housing 12 can be configured not to receive a card edge of a mating connector. For example, the housing can be included in backplane connectors, open-pin-field connectors, mezzanine connectors, column-based connectors, connectors with interleaved cross-talk shields between immediately adjacent rows or columns of differential-signal-pair conductors, connectors with at least three evenly spaced rows or columns of differential-signal-pair conductors, connectors with stamped-blade conductors, connectors with conductors that are configured to mate with stamped-blade conductors, or other similar connectors including cabled-versions of such connectors. The signal conductors, including differential signal pairs 28 and ground conductors 32, can be arranged in two parallel rows on opposed sides of the slot.

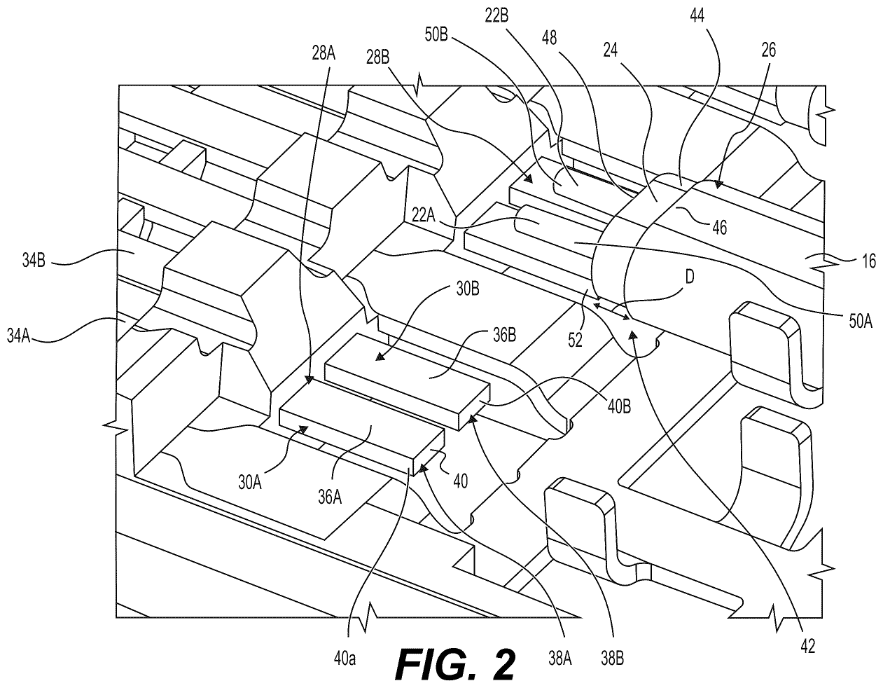

As shown in FIG. 2, each first electrical conductor 30A can include a respective first portion, such as a first mate portion 34A and a respective, first opposed portion, such as a first mount portion 36A. Each second electrical conductor 30B can include a respective second portion, such as a second mate portion 34B and a respective, second opposed portion, such as second mount portion 36B. The first and second mate portions 34A, 34B can each be configured to mate with a respective, corresponding mating connector or mating card edge. Each first mount portion 36A can define a respective first material thickness edge 38A. Each second mount portion 36B can define a respective second material thickness edge 38B.

Each respective first material thickness edge 38A and/or each respective first mount portion 36A can carry, can receive, or can be coated with an electrically non-conductive barrier 40, such as first barrier 40A. The first electrical conductor 30A, including the first mount portion 36A, may not extend through the barrier 40A. Each respective second material thickness edge 38B and/or each respective second mount portion 36B can carry, can receive, or can be coated with an electrically non-conductive barrier 40, such as second barrier 40B. The second electrical conductor 30B, including the first mount portion 36B, may not extend through the barrier 40A. The electrically non-conductive barrier 40, the first barrier 40A, the second barrier 40B, or one or more of the electrically non-conductive barrier 40 and the first and second barriers 40A, 40B can be made from an electrically non-conductive polymer, an electrically non-conductive paint, an electrically non-conductive plastic, or any electrically non-conductive material. The first barrier 40A, the second barrier 40B, or both the first and second barriers 40A, 40B can be applied to any one or more of the first material thickness edge 38A, the second material thickness edge 38B, the first mount portion 36A, and/or the second mount portion 36B as a liquid, a spray, a gel, an insert, or other suitable method. The first barrier 40A and the second barrier 40B can be physically separated from one another such that a common electrically non-conductive barrier 40 does not extend between the first and second mount portions 36A, 36B. Stated another way, the first material thickness edge 38A, the second material thickness edge 38B, the first mount portion 36A, and/or the second mount portion 36B can receive its own respective, discrete first barrier 40A or its own respective, discrete second barrier 40B. The first and second cable conductors 22A, 22B can each extend over a respective first or second barrier 40A, 40B. The first and second cable conductors 22A, 22B can each extend over a respective first or second barrier 40A, 40B without passing through or entirely through the respective first barrier 40A, the respective second barrier 40B, or both the first and second barriers 40A, 40B. The first barrier 40A, the second barrier 40B, or both the first and second barriers 40A, 40B can be attached to or only carried by any one or more of the first material thickness edge 38A, the second material thickness edge 38B, the first mount portion 36A, and/or the second mount portion 36B and not carried by the cable 16 or the first cable conductor 22A or the second cable conductor 22B. The barrier 40 (first barrier 40A and/or second barrier 40B) can be a film that is only a few microns thick. For example, the first barrier 40A can have a thickness greater than approximately zero microns and less than or equal to approximately 1 micron, less than or equal to 10 microns, less than or equal to 100 microns, or any value greater than approximately zero microns and less than or equal to any one of 1 micron, 10 microns, and 100 microns. As one example, the barrier 40 (first barrier 40A and/or second barrier 40B) can be an epoxy that is applied in one to three passes each of approximately 1 micron to approximately 1.5 microns. The epoxy can be LOCTITE, for example. As another example, the barrier 40 (first barrier 40A and/or second barrier 40B) can be a polyimide that is applied in one to three passes each of approximately 0.75 microns to approximately 1 micron. A thickness of the barrier 40 (first barrier 40A and/or second barrier 40B) can be increased for low impedance implementations. For example, a thickness of the barrier 40 (first barrier 40A and/or second barrier 40B) can be about 50 microns for a very low impedance implementation. In FIGS. 1 and 2, barrier 40 (first barrier 40A and/or second barrier 40B) is applied to the first electrical conductor 30A and the second electrical conductor 30B that are included in a connector with a leadframe housing 20. The barrier 40 can be carried only by the leadframe housing. But the connector in FIGS. 1 and 2 is one example of the type of connectors that can be used, and the barrier 40 can be applied to any electrical contact that is directly attached to a cable conductor of a cable with a cable shield. Barrier 40 can be applied to a contact that transports, i.e., transmits or receives, singled-ended or differential signals.

A cable strip region 42 can be referred to as the amount of the cable shield 26 that is removed from the cable 16 or as the amount of the cable dielectric 24 that is exposed or unshielded. The cable strip region 42 can be refer to an exposed area 44 of the cable dielectric 24 or a distance D of exposed cable dielectric 24. Stated another way, the cable strip region 42 can be defined as a distance D between the first material thickness edge 38A or the corresponding first barrier 40A and a shield edge 46 of the cable shield 26. Similarly, the cable strip region 42 can be defined as a distance D between the second material thickness edge 38B or the corresponding second barrier 40B and a shield edge 46 of the cable shield 26. The cable strip region 42 can be numerically zero or as close to a zero distance as possible, which can mean that the shield edge 46 of the cable shield 26 can be coincident with a cable dielectric edge 48. That is, the amount of the cable dielectric 24 that is exposed or unshielded can be zero or an amount that is as close to a zero distance as possible.

Reducing the size, area, or distance of the cable strip region 42 can allow the first and the second cable conductors 22A, 22B to be fully or circumferentially shielded by the cable shield 26 up to any one, any two, or all of the respective first material thickness edge 38A, the respective second material thickness edge 38B, and/or the respective first and second barriers 40A, 40B of the respective first and second mount portions 36A, 36B without inadvertently or undesirably electrically shorting one or both of the corresponding first and second electrical conductors 30A, 30B with the cable shield 26. The cable strip region 42 can be defined by distance between the shield edge 46 and the cable dielectric edge selected from any one of approximately 0.0 mm, approximately 0.00 mm, approximately 0.01±0.009 mm, approximately 0.02±0.009 mm, approximately 0.03±0.009 mm, approximately 0.04±0.009 mm, approximately 0.05±0.009 mm, approximately 0.06±0.009 mm, approximately 0.07±0.009 mm, approximately 0.08±0.009 mm, approximately 0.09±0.009 mm, approximately 0.1±0.09 mm, approximately 0.2 mm, approximately 0.2±0.04 mm, approximately 0.25 mm, approximately 0.3±0.04 mm, approximately 0.4±0.05 mm, and approximately 0.5±0.05 mm. Stated another way, the cable strip region 42 can be any measurement value that is greater than or equal to 0.0 mm or greater than or equal to 0.00 mm and less than or equal to 0.24 mm. Stated another way, the cable strip region 42 can be any measurement value the is greater than or equal to 0.0 mm or greater than or equal to 0.00 mm and less than or equal to 0.50 mm.

A first exposed cable conductor 50A can be electrically attached, physically attached, or both electrically and physical attached to the first mount portion 36A. A second exposed cable conductor 50B can be electrically attached, physically attached, or both electrically and physically attached to the second mount portion 36B. A gap 52 between (i) the cable dielectric edge 48, the cable shield 26, or both the cable dielectric edge 48 and the cable shield 26 and (ii) any one or more of the first material thickness edge 38A, the second material thickness edge 38B, the first barrier 40A, and/or the second barrier 40B can be defined as or by a distance of any one of approximately 0.0 mm, approximately 0.00 mm, approximately 0.01±0.009 mm, approximately 0.02±0.009 mm, approximately 0.03±0.009 mm, approximately 0.04±0.009 mm, approximately 0.05±0.009 mm, approximately 0.06±0.009 mm, approximately 0.07±0.009 mm, approximately 0.08±0.009 mm, approximately 0.09±0.009 mm, approximately 0.1±0.09 mm, approximately 0.2 mm, approximately 0.2±0.04 mm, approximately 0.25 mm, approximately 0.3±0.04 mm, approximately 0.4±0.05 mm, and approximately 0.5±0.05 mm. Stated another way, the cable dielectric edge 48, the cable shield 26, or both the cable dielectric edge 48 and the cable shield 26 can be spaced from one or more of first material thickness edge 38A, the second material thickness edge 38B, the first barrier 40A, and/or the second barrier 40B by any measurement value that is greater than or equal to 0.0 mm or greater than or equal to 0.00 mm and less than or equal to 0.24 mm. Stated another way, the gap 52 can be any measurement value the is greater than or equal to 0.0 mm or greater than or equal to 0.00 mm and less than or equal to 0.50 mm.

Referring to both FIGS. 1 and 2, an electrical connector 10 can include a first electrical conductor 30A. The first electrical conductor 30A can define a first material thickness edge 38A. An electrically non-conductive barrier 40, such as a first barrier 40A, can be positioned on or adjacent to the first material thickness edge 38A, only on or adjacent to the first material thickness edge 38A, or only on or adjacent to the first material thickness edge 38A and the first mount portion 36A. A second electrical conductor 30B can define a second material thickness edge 38B. An electrically non-conductive barrier 40, such as second barrier 40B, can be positioned on or adjacent to the second material thickness edge 38B, only on or adjacent to the second material thickness edge 38B, or only on or adjacent to the second material thickness edge 38B and the second mount portion 36B.

The electrical connector 10 can further include a cable 16. The cable 16 can include a cable shield 26. The cable shield 26 can be electrically insulated from the first material thickness edge 38A of the first mount portion 36A by the first barrier 40A. The cable shield 26 can be electrically insulated from the second material thickness edge 38B by the second barrier 40B. The cable shield 26 can define a shield edge 46. The shield edge 46 can be spaced from one or more of the respective first material thickness edge 38A, the respective second material thickness edge 38B, the respective first barrier 40A, and the second barrier 40B by any one of approximately 0.0 mm, approximately 0.00 mm, approximately 0.01±0.009 mm, approximately 0.02±0.009 mm, approximately 0.03±0.009 mm, approximately 0.04±0.009 mm, approximately 0.05±0.009 mm, approximately 0.06±0.009 mm, approximately 0.07±0.009 mm, approximately 0.08±0.009 mm, approximately 0.09±0.009 mm, approximately 0.1±0.09 mm, approximately 0.2 mm, approximately 0.2±0.04 mm, approximately 0.25 mm, approximately 0.3±0.04 mm, approximately 0.4±0.05 mm, and approximately 0.5±0.05 mm. Stated another way, the shield edge 46 can be spaced from one or more of a respective first material thickness edge 38A, a respective second material thickness edge 38B, a respective first barrier 40A, and a second barrier 40B by any measurement value that is greater than or equal to approximately 0.0 mm or greater than or equal to approximately 0.00 mm and less than or equal to approximately 0.24 mm. Stated another way, the shield edge 46 can be spaced from one or more of a respective first material thickness edge 38A, a respective second material thickness edge 38B, a respective first barrier 40A, and a respective second barrier 40B by any measurement value that is greater than or equal to 0.0 mm or greater than or equal to 0.00 mm and less than or equal to approximately 0.50 mm. A first cable conductor 22A can be electrically connected, physically connected, or both electrically and physically connected to the first mount portion 36A of the first electrical conductor 30A. A second cable conductor 22B can be electrically connected, physically connected, or both electrically and physically connected to the second mount portion 36B of the second electrical conductor 30B.

Referring to both FIGS. 1 and 2, an electrical connector 10 can include a leadframe housing 20. A first differential signal pair 28A can be carried by the leadframe housing 20. The first differential signal pair 28A can include the first electrical conductor 30A and the second electrical conductor 30B. The first electrical conductor 20A can include the first mount portion 36A. The second electrical conductor 30B can include a second mount portion 36B. The first mount portion 36A can include the first material thickness edge 38A. The second mount portion 36B can include the second material thickness edge 38B. A cable 16, such as a twin axial cable, can be electrically connected, physically connected, or both electrically and physically connected to the respective first electrical conductor 30A and the respective second electrical conductor 30B. The cable 16, such as a twin axial cable, can include the cable shield 26. The cable shield 26 can define the shield edge 46. The shield edge 46 can be spaced approximately 0.0 mm, approximately 0.00 mm, approximately 0.01±0.009 mm, approximately 0.02±0.009 mm, approximately 0.03±0.009 mm, approximately 0.04±0.009 mm, approximately 0.05±0.009 mm, approximately 0.06±0.009 mm, approximately 0.07±0.009 mm, approximately 0.08±0.009 mm, approximately 0.09±0.009 mm, approximately 0.1±0.09 mm, approximately 0.2 mm, approximately 0.2±0.04 mm, approximately 0.25 mm, approximately 0.3±0.04 mm, approximately 0.4±0.05 mm, and approximately 0.5±0.05 mm from the first material thickness edge 38A, the second material thickness edge 38B, both of the respective first and second barriers 40A, 40B, and/or the cable dielectric edge 48. Stated another way, the shield edge 46 can be spaced from one or more of a respective first material thickness edge 38A, a respective second material thickness edge 38B, a respective first barrier 40A, a respective second barrier 40B, and/or the cable dielectric edge 48 by any measurement value that is greater than or equal to 0.0 mm or greater than or equal to 0.00 mm and less than or equal to 0.24 mm. Stated another way, the shield edge 46 can be spaced from one or more of a respective first material thickness edge 38A, a respective second material thickness edge 38B, a respective first barrier 40A, a respective second barrier 40B, or the cable dielectric edge 48 by any measurement value that is greater than or equal to 0.0 mm or greater than or equal to 0.00 mm and less than or equal to 0.50 mm. For clarity, any range of ±0.09 mm disclosed in this disclosure includes any value within that range, such as ±0.01 mm, ±0.02 mm, ±0.03 mm, ±0.04 mm, ±0.05 mm, ±0.06 mm, ±0.07 mm, ±0.08 mm and ±0.09 mm, as well as all smaller values in the range such as ±0.001 mm, etc. A range of ±0.05 mm disclosed herein includes any value within that range, such as ±0.01 mm, ±0.02 mm, ±0.03 mm, ±0.04 mm and ±0.05 mm, as well as all smaller values in the range such as ±0.001 mm, etc.

Referring to both FIGS. 1 and 2, the electrical connector 10 can include the leadframe housing 20. The first differential signal pair 28A can be carried by the leadframe housing 20. The first differential signal pair 28A can include the first electrical conductor 30A and the second electrical conductor 30B. The first electrical conductor 30A can include the first mount portion 36A. The second electrical conductor 30B can include the second mount portion 36B. The first mount portion 36A can define or can form the first material thickness edge 38A. The second mount portion 36B can include the second material thickness edge 38B. The first barrier 40A can be positioned on or adjacent to or can be non-removably attached to the first material thickness edge 38A. The second electrically dielectric barrier 40B can be positioned on or adjacent to or can be non-removably attached to the second material edge 38B. The cable 16, such as a twin axial cable, or the respective first and second cable conductors 22A, 22B can be electrically connected, physically connected, or both electrically and physically connected to a respective first electrical conductor 30A and a respective second electrical conductor 30B.

The cable 16, such as a twin axial cable, can include a cable dielectric 24 and a cable shield 26. The cable dielectric 24 can define a cable dielectric edge 48. The cable shield 26 can define a shield edge 46. The shield edge 46, the cable dielectric edge 48, or both the shield edge 46 and the cable dielectric edge 48 can be spaced greater than or equal to approximately 0.0 mm or approximately 0.00 mm but less than or equal to any one of approximately 0.01±0.009 mm, approximately 0.02±0.009 mm, approximately 0.03±0.009 mm, approximately 0.04±0.009 mm, approximately 0.05±0.009 mm, approximately 0.06±0.009 mm, approximately 0.07±0.009 mm, approximately 0.08±0.009 mm, approximately 0.09±0.009 mm, approximately 0.1±0.09 mm, approximately 0.2 mm, approximately 0.2±0.04 mm, approximately 0.25 mm, approximately 0.3±0.04 mm, approximately 0.4±0.05 mm, and approximately 0.5±0.05 mm from one or more of the first material thickness edge 38A, the second material thickness edge 38B, the respective first barrier 40A, and the respective second barriers 40B. Stated another way, the shield edge 46, the cable dielectric edge 48, or both the shield edge 46 and the cable dielectric edge 48 can be spaced from one or more of a respective first material thickness edge 38A, a respective second material thickness edge 38B, a respective first barrier 40A, and/or a respective second barrier 40B by any measurement value that is greater than or equal to 0.0 mm or greater than or equal to 0.00 mm and less than or equal to 0.24 mm. Stated another way, the shield edge 46, the cable dielectric edge 48, or both the shield edge 46 and the cable dielectric edge 48 can be spaced from one or more of a respective first material thickness edge 38A, a respective second material thickness edge 38B, a respective first barrier 40A, and/or a respective second barrier 40B by any measurement value the is greater than or equal to 0.0 mm or greater than or equal to 0.00 mm and less than or equal to 0.50 mm.

Referring to both FIGS. 1 and 2, an electrical connector 10 can include a first electrical conductor 30A that defines a first material thickness edge 38A and a second electrical conductor 30B that defines a second material thickness edge 38B. An electrically non-conductive first barrier 40A can be positioned on the first material thickness edge 38A. An electrically non-conductive second barrier 40B can be positioned on the second material thickness edge 38B. The first barrier 40A and the second barrier 40B can be discrete, independent portions. The first and second barriers 40A, 40B can be configured to not span both the first electrical conductor 30A and the second electrical conductor 30B. The first and second barriers 40A, 40B can each be configured to not receive or do not receive a first cable conductor 22A, a second cable conductor 22B, or both the first cable conductor 22A and the second cable conductor 22B. That is, some of the first and second barriers 40A, 40B do not have to be connected to a corresponding cable conductor.

As explained above, the first barrier 40A can be non-removably attached to the first electrical conductor 30A, and the second barrier 40B can be non-removably attached to the second electrical conductor 30B. That is, the first barrier 40A can be permanently attached to the first electrical conductor 30A, and the second barrier 40B can be permanently attached to the second electrical conductor 30B. As further explained above, the first electrical conductor 30A can be coated with the first barrier 40A, and the second electrical conductor 30B can be coated with the second barrier 40B. The first barrier 40A and the second barrier 40B can respectively coat the electrical conductor 30A and the second electrical conductor 30B with a single dipping operation, for example, thereby reducing the overall cost and complexity of manufacturing the electrical connector 10. Finally, as also explained above, the first electrical conductor 30A and the second electrical conductor 30B can be carried by the leadframe housing 20. In addition, the first barrier 40A can be carried by the leadframe housing 20, and the second barrier 40B can be carried by the leadframe housing 20. One or both of the first barrier 40A and the second barrier 40B can be non-removably attached or permanently attached to the leadframe housing 20.

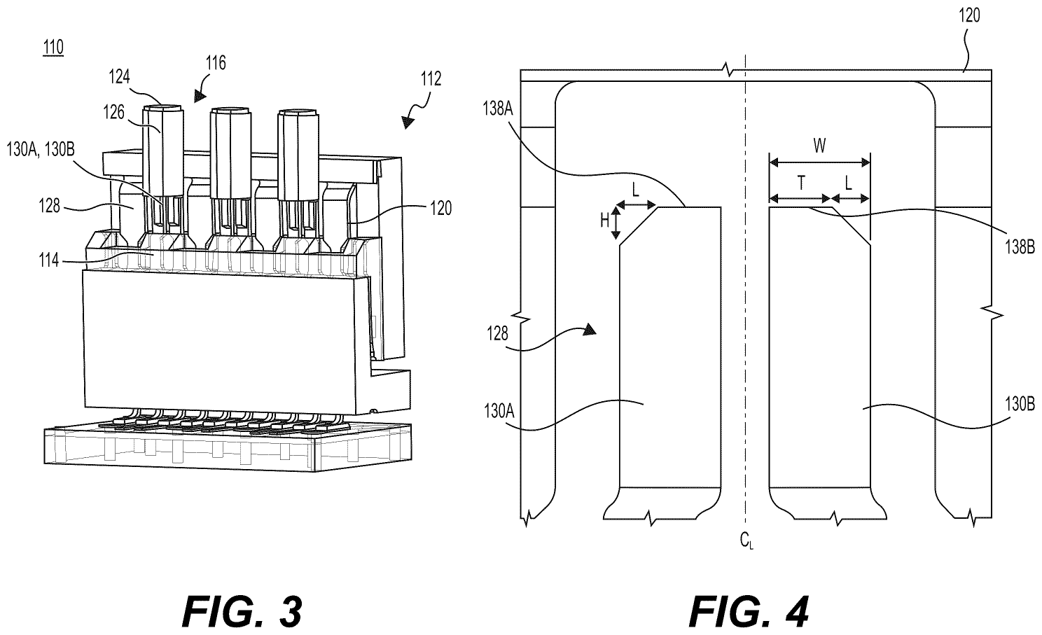

FIG. 3 shows a second electrical connector, such as an electrical cable connector 110. Electrical cable connector 110 can include elements similar to the first electrical cable connector 10 shown in FIG. 1. Electrical cable connector 110 can include an electrically insulative, dielectric housing 112; at least one, at least two, at least three, at least four, or four or more electrical conductors 114; one, at least one, at least two, at least three, at least four, or four or more cables 116, such as coaxial, flex, discrete, or twin axial cables; an optional EMI shield (not shown); optional interleaved crosstalk shields (not shown), and an electrically insulative, dielectric overmolded leadframe housing 120. Alternatively, the leadframe housing 120 can be omitted, and the electrical conductors 114 can be stitched into housing 112. Each cable 116 can include at least one first cable conductor 122A and/or at least one second cable conductor 122B. Further, each electrical cable 116 can include a cable dielectric 124 and a cable shield 126. The materials included in the second electrical cable connector 110 can be the same as, or similar to, the materials described above with respect to the first electrical cable connector 10.

As shown in FIG. 4, the dielectric overmolded leadframe housing 120 of the second electrical cable connector 110 can carry electrical conductors or contacts. The electrical conductors can be signal conductors and/or ground conductors. The signal conductors can be single ended or can be paired in differential signal pairs. The signal conductors can include chamfered surfaces or corners. The signal conductors can include differential signal pairs 128 that include a first electrical conductor 130A and a second electrical conductor 130B with chamfered surfaces, in contrast to the first electrical cable connector 110 shown in FIG. 1. The chamfered surfaces of each of the first electrical conductor 130A and the second electrical conductor 130B can be symmetric about a longitudinal centerline CL between the first electrical conductor 130A and the second electrical conductor 130B. The chamfered surfaces of each of the first electrical conductor 130A and the second electrical conductor 130B can be applied in equal or substantially equal distances along the length and width of each of the first electrical conductor 130A and the second electrical conductor 130B, such that the void space left by the chamfer defines an isosceles right triangle.

As shown in FIG. 4, a first material thickness edge 138A of the first electrical conductor 130A (i.e., a first cable attachment end) and a second material thickness edge 138B of the second electrical conductor 130B (i.e., a second cable attachment end) can be positioned perpendicular or substantially perpendicular to the edges of the first electrical conductor 130A and the second electrical conductor 130B, i.e., the first material thickness edge 138A of the first electrical conductor 130A and/or the second material thickness edge 138B of the second electrical conductor 130B can define a 90° angle or substantially 90° angle with the edges of the first electrical conductor 130A and/or the second electrical conductor 130B. A first material thickness edge 138A of the first electrical conductor 130A and a second material thickness edge 138B of the second electrical conductor 130B can have a width W, and a chamfer can be applied along a length L of the width W along an edge of the first electrical conductor 130A or the second electrical conductor 130B closest to the exposed cable shield 126. When the cable strip region is zero mm or approximately zero mm such that the cable dielectric 124 and the cable shield 126 both terminate in the same plane or when there is a negative cable strip region such that the exposed cable shield 126 extends beyond or over the corresponding exposed cable dielectric 124 or extends beyond or over the first material thickness edge 138A of the first electrical conductor 130A and/or the second material thickness edge 138B of the second electrical conductor 130B, there is an air gap or only an air gap between the exposed cable shield 126 and the first electrical conductor 130A or the second electrical conductor 130B that prevents shorting between the cable shield 126 and each of the first electrical conductor 130A and the second electrical conductor 130B. Alternatively, when the cable strip region is zero mm or approximately zero mm such that the cable dielectric 124 and the cable shield 126 both terminate in the same plane or when there is a negative cable strip region such that the exposed cable shield 126 extends beyond or over the exposed cable dielectric 124 or extends beyond or over the first material thickness edge 138A of the first electrical conductor 130A and/or the second material thickness edge 138B of the second electrical conductor 130B, the first electrical conductor 130A and/or the second electrical conductor 130B can be in direct physical contact with the exposed cable dielectric 124 without the first electrical conductor 130A and/or the second electrical conductor 130B shorting with cable shield 126. Accordingly, a mounting portion or unchamfered portion T remains for each of the first material thickness edge 138A of the first electrical conductor 130A and the second material thickness edge 138B of the second electrical conductor 130B. In addition, the chamfer can be applied along a height H of each of the first electrical conductor 130A and the second electrical conductor 130B. As described above, the length L and the height H can be the same or substantially the same within manufacturing and/or measurement tolerances, such that the void space left by the chamfer defines an isosceles right triangle. However, the length L and the width height H can be different, such that an angle defined between the chamfered surface and the first material thickness edge 138A of the first electrical conductor 130A or the second material thickness edge 138B of the second electrical conductor 130B is between 0° and 90°. Furthermore, the length L and the height H of the first electrical conductor 130A can be different from the length L and the height H of the second electrical conductor 130B.

In FIG. 4, the length L can be less than or equal to about ⅔ of the width W within manufacturing and/or measurement tolerances, or the length L can also be less than or equal to about 50% of the width W within manufacturing and/or measurement tolerances. As one example, for an electrical conductor having a width W of about 0.013 inch (0.3302 mm), a length L and a height H of a chamfer can each be between about 0.001 inch (0.0254 mm) and 0.007 inch (0.1778 mm).

Features of the electrical cable connector 10 shown in FIGS. 1 and 2 and the electrical cable connector 110 shown in FIGS. 3 and 4 can be combined, modified, and/or replaced with one another. For example, the first barrier 40A as shown in FIG. 2 can be provided on a first material thickness edge 138A of the first electrical conductor 130A shown in FIG. 4, and the second barrier 40B as shown in FIG. 2 can be provided on a second material thickness edge 138B of the second electrical conductor 130B shown in FIG. 4.

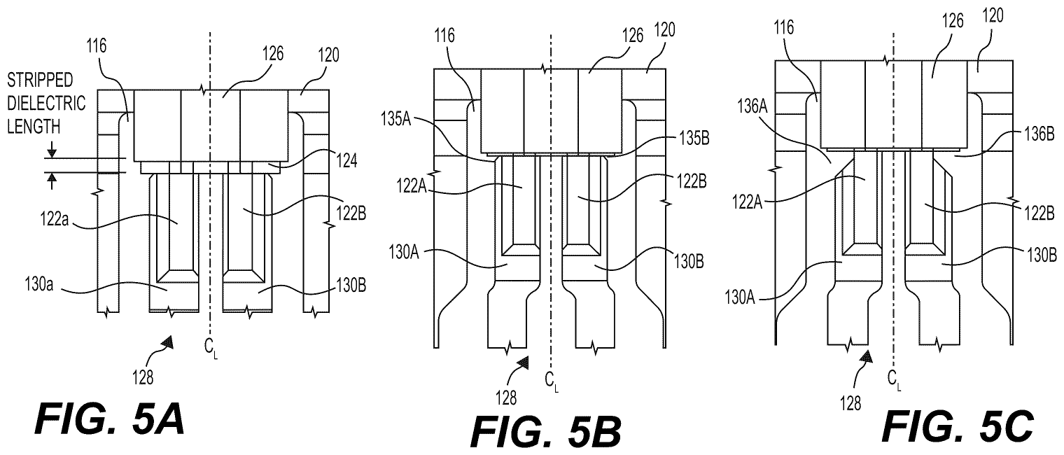

FIGS. 5A to 5C show examples of implementations of components included in the leadframe housing 120 shown in FIG. 4.

As shown in FIG. 5A, a portion of the cable shield 126 of the cable 116 can be stripped to expose a portion of the cable dielectric 124, i.e. a cable strip region similar to the cable strip region 42 discussed above. The length of the cable strip region of the cable 116 with respect to the first electrical conductor 130A and/or the second electrical conductor 130B can be the same as discussed above. The cable shield 126 can be stripped to a predetermined distance, and may be stripped in a single step or in a series of steps to accurately obtain the predetermined distance. For example, the cable shield 126 may be stripped to expose a length of the cable dielectric of approximately 0.003 inch (0.0762 mm) or less. Alternatively, stripping of the cable shield 126 may be omitted.

As shown in FIG. 5B, a chamfer 135A can be applied to the first electrical conductor 130A and a chamfer 135B can be applied to the second electrical conductor 130B. Each of the chamfers 135A and 135B can be approximately 0.001 inch (0.0254 mm) along a width and/or a length of each of the first electrical conductor 130A and a second electrical conductor 130B. The chamfers 135A and 135B can be symmetrical about the longitudinal centerline CL between the first electrical conductor 130A and the second electrical conductor 130B.

As shown in FIG. 5C, a chamfer 136A can be applied to the first electrical conductor 130A and a chamfer 136B can be applied second electrical conductor 130B. The chamfers 136A and 136B can be applied in a single operation, or as a subsequent step to the chamfers 135A and 135B shown in FIG. 5B. Each of the chamfers 136A and 136B can be approximately 0.007 inch (0.1778 mm) or less along a width and/or a length of each of the first electrical conductor 130A and a second electrical conductor 130B. The chamfers 136A and 136B can be symmetrical about the longitudinal centerline CL between the first electrical conductor 130A and the second electrical conductor 130B.

It is again noted that FIGS. 5A to 5C show examples, and the chamfers 135A, 135B, 136A, and 136B can be adjusted or changed as described above with respect to FIG. 4.

By chamfering surfaces of the first electrical conductor 130A and the second electrical conductor 130B as explained above, portions of the first electrical conductor 130A and the second electrical conductor 130B that are closest to the cable shield 126 can be removed, thereby significantly reducing or preventing shorting from the first electrical conductor 130A and the second electrical conductor 130B to the cable shield 126. Furthermore, a significant improvement in signal integrity, particularly with respect to impedance variation and grouping, can be provided by chamfering surfaces of the first electrical conductor 130A and the second electrical conductor 130B. Furthermore, the above-described advantages can be provided with a relatively small reduction in termination impedance, for example, between approximately one Ω and approximately three Ω.

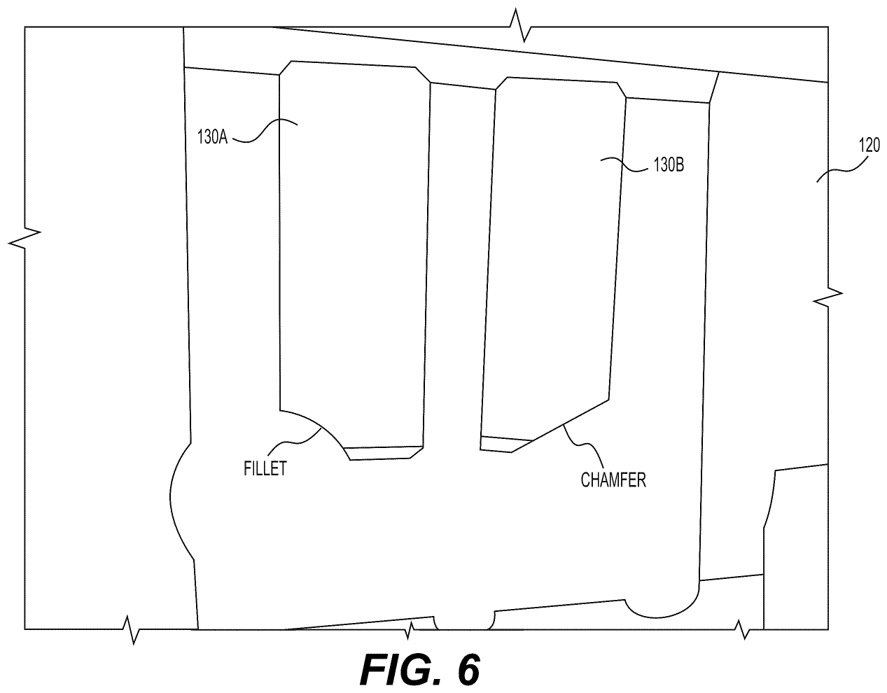

FIG. 6 is a cross-sectional side view of an experimental example of components included in the leadframe housing 120 of the second electrical connector 110 shown in FIG. 3. As shown in FIG. 6, the chamfers that may be applied to surfaces of the first electrical conductor 130A and the second electrical conductor 130B can be implemented as semi-circular shapes, in addition to the straight chamfered surfaces shown in FIGS. 4 to 5C. Although FIG. 6 shows that the first electrical conductor 130A includes a fillet and that the second electrical conductor 130B includes a chamfer, the present invention is not limited to these structures. Semi-circular shapes, such as the fillet of the first electrical conductor 130A in FIG. 6, and straight lines, such as the chamfer of the second electrical conductor 130B in FIG. 6, can be applied to individually or in combination on surfaces of one or both of the first electrical conductor 130A and the second electrical conductor 130B.

The differential total dynamic range of the connector becomes tighter as less of the cable shield 126 is stripped, and providing the first electrical conductor 130A and the second electrical conductor 130B with chamfers does not significantly affect the signal integrity of the second electrical connector 110. However, as explained above, chamfering surfaces of the first electrical conductor 130A and the second electrical conductor 130B is able to significantly reduce or prevent shorting from the first electrical conductor 130A and the second electrical conductor 130B to the cable shield 126, particularly as a stripped length of the cable 126 decreases.

It has been found that differential impedance (Ω) when the dielectric length is approximately zero mils, approximately 1 mils, approximately 3 mils, approximately 5 mils, or approximately 7 mils, is closer to 100Ω with a 7 mil chamfer versus a 1 mil chamfer. In general, differential impedance rises as the chamfer increases from 1 mils to 3 mils to 5 mils to 7 mils.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1: An electrical connector comprising:
a leadframe housing;
a first electrical conductor that defines a first material thickness edge; and
an electrically non-conductive barrier positioned on or adjacent to the first material thickness edge, wherein
the barrier is carried by the leadframe housing.

2: The electrical connector of claim 1, further comprising:
a second electrical conductor that defines a second material thickness edge; and
an electrically non-conductive barrier positioned on or adjacent to the second material thickness edge.

3: The electrical connector of claim 1, further comprising a cable that includes a cable shield, wherein the cable shield is electrically insulated from the first material thickness edge.

4: The electrical connector of claim 2, further comprising a cable that includes a cable shield, wherein the cable shield is electrically insulated from the second material thickness edge.

5: The electrical connector of claim 4, wherein the cable shield defines a shield edge, and the shield edge is positioned approximately greater than 0 mm to approximately 0.24 mm from the second material thickness edge.

6: The electrical connector of claim 1, further comprising a first cable conductor electrically connected, physically connected, or both electrically and physically connected to a first mount portion of the first electrical conductor.

7: The electrical connector of claim 1, further comprising a second electrical conductor and a second cable conductor electrically connected, physically connected, or both electrically and physically connected to a second mount portion of the second electrical conductor.

8: The electrical connector of claim 1, wherein the barrier is non-removably attached to the leadframe housing.

9: The electrical connector of claim 1, wherein the barrier is configured to be provided by a single dipping operation.

10: An electrical connector comprising:
a leadframe housing;
a first differential signal pair carried by the leadframe housing, the first differential signal pair including a first electrical conductor and a second electrical conductor, the first electrical conductor including a first mount portion and the second electrical conductor including a second mount portion, the first mount portion including a first material thickness edge and the second mount portion including a second material thickness edge; and
a twin axial cable electrically connected, physically connected, or both electrically and physically connected to the respective first electrical conductor and the respective second electrical conductor, wherein
the twin axial cable includes a cable shield, the cable shield defines a shield edge, and the shield edge either:
is spaced greater than approximately 0 mm but less or equal to approximately 0.24 mm from the first material thickness edge and/or the second material thickness edge; or
extends beyond or over the first material thickness edge and/or the second material thickness edge.

11: The electrical connector of claim 10, wherein the shield edge is spaced greater than approximately 0 mm but less than 0.25 mm from the first material thickness edge and/or the second material thickness edge.

12: The electrical connector of claim 10, wherein the shield edge is spaced greater than approximately 0 mm but less than approximately 0.5 mm from the first material thickness edge and/or the second material thickness edge.

13: The electrical connector of claim 10, wherein the shield edge is spaced greater than approximately 0 mm but less than approximately 1 mm from the first material thickness edge and the second material thickness edge.

14: An electrical connector comprising:
a leadframe housing;
a first differential signal pair carried by the leadframe housing, the first differential signal pair including a first electrical conductor and a second electrical conductor, the first electrical conductor including a first mount portion and the second electrical conductor including a second mount portion, the first mount portion including a first material thickness edge and the second mount portion including a second material thickness edge, a first barrier positioned on or adjacent to the first material thickness edge and a second electrically dielectric barrier positioned on or adjacent to the second material edge; and
a twin axial cable electrically connected, physically connected, or both electrically and physically connected to the respective first electrical conductor and the respective second electrical conductor, wherein
the twin axial cable includes a cable shield, the cable shield defines a shield edge, and the shield edge is spaced greater than approximately 0 mm but less than approximately 0.24 mm from the first and/or the second electrically dielectric barriers.

15: An electrical connector comprising:
a first electrical conductor that defines a first material thickness edge;
a second electrical conductor that defines a second material thickness edge;
an electrically non-conductive first barrier positioned on the first material thickness edge; and
an electrically non-conductive second barrier positioned on the second material thickness edge, wherein
the first barrier and the second barrier are discrete and independent.

16: The electrical connector of claim 15, wherein the first and the second barriers do not span both the first electrical conductor and the second electrical conductor.

17: The electrical connector of claim 15, wherein the first and the second barriers do not receive a first cable conductor, a second cable conductor, or both the first and the second cable conductors.

18: The electrical connector of claim 15, wherein the first barrier has a thickness greater than approximately zero microns and less than or equal to one micron.

19: The electrical connector of claim 15, wherein the first barrier has a thickness greater than approximately zero microns and less than or equal to approximately ten microns.

20-38. (canceled)
